(19) United States
(12) Patent Application Publication
(10) Pub. No.: US 2023/0312945 A1
(43) Pub. Date: Oct. 5, 2023

(54) Pigment Composition And Coloring Method

(71) Applicant: SEIKO EPSON CORPORATION, Tokyo (JP)

(72) Inventors: Mitsunobu NAKATANI, Shiojiri (JP); Kei HIRUMA, Chino (JP); Tomoyuki USHIYAMA, Chino (JP); Kenta TSUKADA, Shiojiri (JP)

(21) Appl. No.: 18/127,713

(22) Filed: Mar. 29, 2023

(30) Foreign Application Priority Data
Mar. 30, 2022 (JP) 2022-056390

(51) Int. Cl. C09D 7/62; C09D 7/20; C09C 3/10; C09D 7/65; C09D 7/40

(52) U.S. Cl. CPC C09D 7/62; C09D 7/20; C09C 3/10; C09D 7/65; C09D 7/70

(57) ABSTRACT

A pigment composition according to an embodiment contains a base-metal pigment, at least one dispersant, and water. The base-metal pigment is metal particles having a surface treated with at least one compound represented by formula (1) or (2):

(R¹—)P(O)(OH)₂ (1)

(R²—O—)ₐP(O)(OH)₃₋ₐ (2)

where R¹ and R² independently represent a hydrocarbon group haying 12 or more carbon atoms, optionally substituted with one or more substituents, and a is 1 or 2. The dispersant includes an amine compound haying a polyester structure, and the pigment composition is an aqueous one.

The present application is based on, and claims priority from JP Application Serial Number 2022-056390, filed Mar. 30, 2022, the disclosure of which is hereby incorporated by reference herein in its entirety.

### BACKGROUND

### 1. Technical Field

The present disclosure relates to a pigment composition and a coloring method.

### 2. Related Art

In the related art, pigment compositions containing a base-metal pigment, such as aluminum, for the production of colored articles having a metallic luster feel have been developed. In recent years, the development of compositions has focused more on aqueous compositions, containing water as their primary solvent, than on nonaqueous compositions, in which the primary solvent is an organic solvent, for reasons such as ecological issues and the ease of handling. For example, JP-A-2015-140359 discloses an aqueous composition containing a base-metal pigment having a surface treated with a fluorine compound.

This aqueous composition, however, is still unsatisfactory in terms of The dispersibility of the base-metal pigment therein and the luster of the colored article made therewith.

### SUMMARY

According to an aspect of the present disclosure, a form of a pigment composition is a pigment composition. containing a base-metal pigment, at least one dispersant, and water, wherein the base-metal pigment is metal particles having a surface treated with at least. one compound represented. by formula (1) or (2)

(R¹—)P(OH)(OH)₂ (1)

(R²—O—)ₐP(O)(OH)₃₋ₐ (2)

where R¹ and R² independently represent a hydrocarbon group having 12 Cr more carbon atoms, optionally substituted with one or more substituents, and a is 1 or 2; the dispersant includes an amine compound having a polyester structure; and the pigment composition is an aqueous one.

According to an aspect of the present disclosure, a form of a coloring method. includes attaching a coloring composition to a substrate, wherein a pigment composition in the above form is the coloring composition.

### DESCRIPTION OF EXEMPLARY EMBODIMENTS

Embodiments of the present disclosure will now be described. The following embodiments are descriptions of examples of the disclosure. The disclosure is never limited to these embodiments and includes variations implemented within the gist of the disclosure. Not all the elements, features, or configurations described below are essential to the disclosure.

### 1. Pigment Composition

A pigment composition according to an embodiment of the present disclosure contains a base-metal pigment, at least one dispersant, and water. The base-metal pigment is metal particles haying a surface treated with at least one compound represented by formula (1) or (2), and the dispersant includes an amine compound having a polyester structure. The pigment composition is an aqueous one.

(R¹—)P(OH)(OH)₂ (1)

(R²—O—)ₐP(O)(OH)₃₋ₐ (2)

(In the formulae, R¹ and R² independently represent a hydrocarbon group having 12 or more carbon atoms, optionally substituted with. one or more substituents. a is 1 or 2)

Base-metal pigments, such as aluminum, for use in aqueous compositions have undergone surface treatment with surface treatment agents, for example to gain water resistance and leafing properties (particles of a base-metal pigment having leafing properties are positioned parallel or substantially parallel with the surface of the substrate to which the pigment is applied, primarily because of surface tension). A common type of surface treatment agent for this purpose is fluorine agents, and researchers have studied surface treatments performed using specific long-chain alkyl phosphoric acid treatment agents superior in, for example, water resistance and dispersion stability and also advantageous with their ecofriendly nature (hereinafter also referred to as “specific surface treatment agents). Even with specific surface treatment agents, however, aqueous compositions containing a base-metal pigment are still unsatisfactory in terms of the dispersibility of the base-metal pigment and the luster of the colored article made therewith.

Recently, it has been found that using an amine compound having a polyester structure as a dispersant leads to excellent dispersion with specific surface treatment agent(s), excellent luster, and excellent water resistance. A possible reason is that the amine compound is activated and positively charged, and therefore is highly soluble in the aqueous composition, at the relatively low pH of the aqueous composition (e.g., an acidic pH near 5) created by the phosphorus-containing acid group (s) in the specific surface treatment agent. The resulting improved compatibility, therefore, seems to be the reason for the good dispersibility, for example. Besides this, this kind of amine compound does not greatly change the acidic pH of the aqueous composition toward the alkaline side. The detachment or replacement of the surface treatment agent on the surface of the base-metal pigment, therefore, is limited, helping achieve good water resistance.

As used herein, a “pigment composition” is a composition containing a pigment. A pigment composition can be of any kind, but examples include coloring compositions and pigment dispersions.

A “coloring composition” is a composition used to color a substrate by being attached to the substrate. A coloring composition can be of any kind, but examples include ink and paint.

A “pigment dispersion” is a composition for use in the preparation of a coloring composition. The concentration of the pigment in a pigment dispersion is relatively high compared with that in coloring compositions and is higher than that in the coloring composition prepared using the pigment dispersion.

The ingredients in the pigment composition according to this embodiment will now be described.

### 1.1 Base-Metal Pigment

The pigment composition according no this embodiment contains a base-metal pigment. The base-metal pigment is metal particles having a surface treated with a specific surface treatment agent as described below. More specifically, the base-metal pigment seems to be a combination of metal particles and a specific surface treatment agent whose phosphorus-containing acid group moiety is chemically bound to the surface of the metal particles. The specific surface treatment agent itself does not need to be bound to the surface of the metal particles, for example by hydrogen bonds or intermolecular forces; the base-metal pigment can be metal particles having a residue of the specific surface treatment agent. That is, the base-metal pigment appears to be a combination of metal particles and a specific surface treatment agent bound together by covalent bonds as a result of OH groups on the surface of the metal particles, which can be present there, reacting with the phosphorus-containing acid group moiety of the specific surface treatment agent. Alternatively, the specific surface treatment agent may be adhering to the surface of the metal particles, for example by physical adsorption. The specific surface treatment agent seems to be adhering to the metal particles in such a way, for example by bonding or physical adsorption.

The base-metal pigment content is riot critical, but preferably is from 0.1% to 30% by mass, more preferably from 0.1% to 15% by mass, even more preferably from 0.1% to 5.0% by mass, still more preferably from 0.3% to 3.0% by mass, in particular from 0.5% to 2.0% by mass, in particular from 0.7% to 1.5% by mass of the total mass of the pigment composition. It is also preferred that the base-metal pigment content be from 10% to 30% by mass, more preferably from 20% to 30% by mass.

When the base-metal pigment content is in these ranges, the dispersion stability of the pigment composition tends to be further improved, and the luster of the composition also tends to be better.

### 1.1 Metal Particles

At least part of the visible exterior of the metal particles is made of a metallic material. For example, the entire metallic particles or a near-surface portion of the particles is made of a metallic material. The metal particles have a function to impart a metallic luster to the colored article produced using the pigment composition.

### Material(s)

The metal particles only need to be made of a metallic material at least in a region including a near-surface portion. For example, the entire metal particles may be made of a metallic material, or the metal particles may have a core made of a nonmetallic material and a coating covering the core and made of a metallic material. The metal particles may have, for example, an oxide coating like a passivation film on their surface.

The metallic material that forms (part of) the metal particles contains, preferably is, a base metal. As used herein, a “base metal” can be any metal that ionizes more easily than hydrogen. Not only pure metals, such as alkali metals, alkaline earth metals, aluminum, iron, zinc, lead, copper, nickel, cobalt, and chromium, but also alloys of such metals are included in this category of metals.

Of such metallic materials, it is particularly preferred that the metal particles be particles of aluminum or an aluminum alloy. Particles of such base metals tend to have better dispersion stability in the pigment composition by virtue of the relatively low relative density of the metals. Such base metals are preferred in terms of giving the particles luster properties and for cost reasons, but they can be oxidized by water present therearound. When this occurs, the metal particles lose their luster properties and easily aggregate together. Metal particles having a surface treated with a specific surface treatment agent as described later herein, however, can enjoy favorable characteristics of such base metals, i.e., good luster properties and good dispersibility.

### Shape

The shape of the metal particles is not critical, but examples include flakes, spheres, spindles, and needles. Of these, flakes are particularly preferred. Using flake-shaped metal particles helps ensure that when the pigment composition is attached to a substrate, particles of the base-metal pigment will be positioned with their primary surface parallel with the surface profile of the substrate. In that case the intrinsic luster properties, for example, of the base-metal pigment tend to be reproduced on the substrate more effectively.

As used herein, “flakes” are a tabular shape, such as a shape in which the particles have a larger area when observed at a predetermined angle (first angle of observation), for example in plan view, than when observed at an angle perpendicular to the first angle of observation.

It is particularly preferred that the ratio S₁/S₀ be 2 or greater, more preferably 5 or greater, even more preferably 8 or greater, still more preferably 10 or greater, in particular 20 or greater, in particular 30 or greater, where S₁ is the area [μm²] of the particles observed in the direction in which the particles have their maximum projected area (first direction of observation), or the area in plan view, and S₀ is the area [μm²] of the particles observed in the direction that is perpendicular to the first direction of observation and in which the particles have a larger projected area than in any other perpendicular direction. There is no particular upper limit, but preferably the ratio S₁/S₀ is 1000 or less, more preferably 500 or less, even more preferably 100 or less, in particular 80 or less. Preferably, S₁/S₀ is from 300 to 700, more preferably from 400 to 600.

Shapes like flat or curved plates are also flake shapes.

This ratio S₁/S₀ can be, for example, a mean determined by observing any 50 particles and averaging calculated ratios. The observation can be made using, for example, an electronic microscope or atomic force microscope. Alternatively, the volume-average particle diameter D50, described later herein, and average thickness of the base-metal pigment may be used. That is, the volume-average particle diameter D50 divided by the average thickness, both in the same unit, may be in doe above ranges.

Preferred ranges of the volume-average diameter D50 and average thickness of the metal. particles can be the same as those for the base-metal pigment, described later herein. Preferred methods for the measurement of these parameters of the metal particles can also be the same as those for the base-metal pigment.

### Method for Production

It is not critical how the metal particles are produced, but preferably, they are obtained by, for example, forming a film of a base metal by vapor-phase film formation and then crushing it. This method is suitable even for the production of relatively thin metal particles, and using this method also helps reduce variations in characteristics between the metal particles.

When the metal particles are produced using such a method, it is preferred that the film of a base metal be formed on, for example, a base material. The base material can be, for example, a plastic film, such as a film of polyethylene terephthalate. The base material may have a release agent layer on the side on which the film is to be formed.

The film is crushed preferably by sonicating it in a liquid. This is an easy way to obtain metal particles having a desired diameter and also helps reduce the occurrence of variations in size, shape, and characteristics between the metal particles.

When the film is crushed by such a method, examples of suitable liquids include alcohols, hydrocarbon compounds, ether compounds, and polar compounds, such as propylene carbonate, γ-butyrolactone, N-methyl-2-pyrrolidone, N,N-dimethylformamide, N,N-dimethylacetamide, dimethylsulfoxide, cyclohexanone, and acetonitrile. Using such a liquid helps reduce the oxidation, for example, of the metal particles and also helps dramatically increase productivity in the production of the metal particles. These liquids also tend to help reduce the occurrence of variations in size, shape, and characteristics between the metal particles.

### 1.1.2 Surface Treatment Agent(s)

The base-metal pigment is metal particles having a surface treated with at least one compound represented by formula (1) or (2) (specific surface treatment agent).

(R¹—)P(OH)(OH)₂ (1)

(R²—O—)ₐP(O)(OH)₃₋ₐ (2)

(In the formulae, R¹ and R² independently represent a hydrocarbon group having 12 or more carbon atoms, optionally substituted. with one or more substituents. a is 1 or 2.)

A compound represented by formula (1) is a compound derived from phosphonic acid by replacing a hydrogen atom with an R¹ group. Such a compound tends to help impart better luster to the base-metal pigment because it is likely to be distributed uniformly on the surface of the metal particles by virtue of little steric hindrance by its R¹ group moiety.

A compound represented by formula (2) is a compound derived from phosphoric acid by esterifying one or two of its three hydroxyl groups with an R² group. When a in formula (2) is 1, or when one of the three hydroxyl groups in phosphoric acid is esterified with an R2 group, the compound tends to help impart better dispersion stability and better luster to the base-metal pigment because it is likely to be distributed uniformly on the surface of the metal particles by virtue of the smaller steric hindrance by its R² group moiety. When a in formula (2) is 2, or when two of the three hydroxyl groups in phosphoric acid are esterified with R² groups, the compound tends to help make the base-metal pigment better at dispersibility and water resistance because it is more effective in keeping water away from the surface of the metal particles. When the surface treatment is with a compound or compounds represented by formula (2), it is preferred that the compound be, or the compounds include, a compound represented by formula (2) in which a is represented by 2

In the above formulae, R¹ and R2 are hydrocarbon groups having a carbon backbone with 12 or more carbon atoms, and these groups are hydrocarbon groups having a backbone formed by a continuous connection of 12 or more carbon atoms. In formula (1), any of the 12 or more carbon atoms in the carbon backbone of R¹ is bound directly to the phosphorus atom P. In formula (2), any of the 12 or more carbon atoms in the carbon backbone of R² is bound directly to the oxygen atom O in the (R—O—), and this oxygen atom is bound directly to the phosphorus atom P. That is, R¹ can be bound to the P at any position, and R² can be bound to the O at any position.

Examples of hydrocarbon groups having a carbon backbone with 12 or more carbon atoms include saturated hydrocarbon groups, which have no carbon-carbon double or triple bond, and unsaturated hydrocarbon groups, which have a carbon-carbon double or triple bond. The hydrocarbon group R¹ or R² may be, for example, an aromatic hydrocarbon group, which has an aromatic ring structure in its carbon backbone, or a chain-shaped or cyclic aliphatic hydrocarbon group. A chain-shaped aliphatic hydrocarbon group is particularly preferred because it leads to, for example, better dispersion stability. A chain-shaped aliphatic hydrocarbon group may be a branched-chain or linear-chain one. A linear-chain aliphatic hydrocarbon group is preferred because it leads to, for example, better dispersion stability, better election stability, and better luster.

For a compound represented by formula (1) or (2), it is preferred that R¹, in formula R¹, or R², in formula (2), be independently a hydrocarbon group having 14 to 34 carbon atoms, more preferably a hydrocarbon group having 15 to 30 carbon atoms, even more preferably a hydrocarbon group having 15 to 26 carbon atoms, in particular a hydrocarbon group having 15 to 22 carbon atoms, in particular a hydrocarbon group having 16 to 20 carbon atoms. When the number of carbon atoms in R¹ or R² is in these ranges, the pigment tends to be better at dispersibility, luster, and water resistance.

In the above formulae, the hydrocarbon groups R¹ and R² may be substituted with one or more substituents. In other words, R¹ and R² only need to contain carbon and hydrogen atoms, have at least a bond between carbon and hydrogen atoms, and one or more hydrogen atoms not replaced with any other atom or any group of atoms.

When having no substituent, R¹ and R² are hydrocarbon groups consisting of carbon and hydrogen atoms. When being chain-shaped aliphatic hydrocarbon groups, for example, R¹ and R² can be alkyl groups, alkenyl groups, alkynyl groups, etc.

When a subset of the hydrogen atoms in the hydrocarbon groups R¹ and R² has been replaced with a substituent, it is preferred that the number of substituents be 50% or less, more preferably 10% or less, of the number of hydrogen atoms the unsubstituted forms of the hydrocarbon groups R¹ and R² would have. Preferably, the number of substituents is five or less, more preferably three or less, even more preferably two or less, in particular one or less. The number of substituents is zero or more, and when R¹ and R² are substituted with substituent(s), the number of substituents is one or more for the lower limit. Preferably, the substituent(s) is on the farthest carbon atom(s) from the P in the formulae; in that case, dispersion stability tends to be better.

Examples of substituents include a carboxyl group, a hydroxyl group, an amino group, and an oxyalkylene-containing group. An oxyalkylene-containing group is a group having an oxyalkylene structure. An oxyalkylene structure is also referred to as an alkylene oxide structure. An oxyalkylene-containing group has one or more alkylene oxide units and may have two or more. In particular, an oxyalkylene-containing group may have a structure formed by multiple repeated alkylene oxide units. Preferably, the number of repetitions of the alkylene oxide unit is ten or less, more preferably four or less. As for the lower limit, the number of repetitions is one or more, preferably two or more, more preferably three or more. Preferably, the number of carbon atoms in the alkylene in the alkylene oxide unit is one or more and four or less.

Preferably, R¹ and R² are unsubstituted hydrocarbon groups, not substituted with a substituent.

Examples of compounds represented by formula (1) include dodecylphosphonic acid (lauryl phosphonic acid), tetradecylphosphonic acid (myristyl phosphonic acid), hexadecylphosphonic acid (cetyl phosphonic acid), and octadecylphosphonic acid (stearyl phosphonic acid). Preferably, one or more selected from these are used. It is more preferred to use one or more selected from hexadecylphosphonic acid and octadecylphosphonic acid, even more preferably octadecylphosphonic acid.

Examples of compounds represented by formula (2) in which a is 1 include monooctyl phosphate, monolauryl phosphate, monoisotridecyl phosphate, and monostearyl phosphate. Preferably, one or more selected from these are used. It is more preferred to use one or more selected from monoisotridecyl phosphate and monostearyl phosphate, even more preferably monostearyl phosphate.

Examples of compounds represented. by formula (2) in which a is 2 include dioctyl phosphate, dilauryl phosphate, diisotridecyl phosphate, and distearyl phosphate. Preferably, one or more selected from these are used. It is more preferred to use one or more selected from diisotridecyl phosphate and distearyl phosphate, even more preferably distearyl phosphate.

Preferably, the amount of the compound represented by formula (1) or (2) in relation to the metal particles, the amount of which is 100% by mass, is from 0.5% to 60% by mass, more preferably from 1% to 50% by mass, more preferably from 5% to 45% by mass, even more preferably from 10% to 40% by mass, in particular from 15% to 37% by mass, in particular from 20% to 35% by mass, in particular from 25% to 35% by mass. It is also preferred that the amount of the compound represented by formula (1) or (2) in relation to the metal particles, the amount of which is 100% by mass, be 20% by mass or more, more preferably 24% by mass or more, even more preferably 27% by mass or more, in particular 30% by mass or more. When this mass is in the indicated ranges, the pigment tends to be better at water resistance.

The above mass is, in other words, the amount of the compound represented by formula (1) or (2) adhering to the surface of the metal particles.

For the same reason, it is preferred that the amount of the compound represented by formula (1) or (2) in relation to the pigment composition, the amount of which is 100% by mass, be from 0.01% to 0.72% by mass, more preferably from 0.10% to 0.60% by mass, even more preferably from 0.20% to 0.50% by mass, in particular from 0.25% to 0.45% by mass, in particular from 0.30% to 0.40% by mass.

This mass is, in other words, the amount of the compound represented by formula (1) or (2) adhering to the surface of the metal particles.

The pigment composition according to this embodiment may contain surface treatment agents other than specific surface treatment agents as described above unless they impair the advantages of this aspect of the present disclosure. An example of such a surface treatment agent is a fluorine compound. Examples of preferred fluorine compounds include compounds composed of elements including fluorine and one or more selected from phosphorus, sulfur, and nitrogen. Specific examples include fluorinated phosphonic acid, fluorinated carboxylic acid, fluorinated sulfonic acid, and their salts.

The metal particles may be produced by forming a film of a metal by vapor-phase film formation and crushing it in a liquid. The surface treatment of the metal particles with the surface treatment agent may be carried out by, for example, mixing the surface treatment agent into the liquid beforehand.

### 1.3 Diameter and Thickness of Particles

Preferably, the volume-average particle diameter D50 of the base-metal pigment is from 3 to 15 μm. In this case, it is more preferred that the D50 be 4 μm or more, even more preferably 5 μm or more, in particular 6 μm or more for the lower limit. As for the upper limit, it is more preferred that the D50 be 13 μm or less, even more preferably 11 μm or less, still more preferably 9 μm or less, in particular 8.5 μm or less, in particular 8 μm or less, in particular 7.5 μm or less. A base-metal pigment having a volume-average particle diameter D50 in these ranges tends to have good water resistance and give a colored article having a better metallic luster by virtue of its large particle diameter when the pigment composition is used as paint. Any ingredients setting down in the paint, furthermore, tend to be easily dispersed.

It is also preferred that the volume-average article diameter D50 of the base-metal pigment be 1 μm or less. In this case, it is more preferred that the D50 be 0.80 μm or less, even more preferably 0.70 μm or less, in particular 0.60 μm or less, in particular 0.50 μm or less for the upper limit. As for the lower limit, it is more preferred that the D50 be 0.10 μm or more, even more preferably 0.20 μm or more, still more preferably 0.30 μm or more, although there is no particular lower limit in this case. A base-metal pigment having a volume-average particle diameter D50 in these ranges tends to help reduce the clogging of nozzles during ink jet ejection when the pigment composition is used as an ink jet ink composition. When having a particle diameter in these ranges, furthermore, the base-metal pigment has good water resistance despite its large specific surface area, and any ingredients settling down in the ink tend to be easily redispersed.

The volume-average particle diameter D50 represents the median diameter in a particle size distribution by volume obtained by analyzing the pigment composition with a laser diffraction/scattering particle size distribution analyzer and is the particle size at which the cumulative percentage volume reaches 50%, or exactly half the total, in a graphical representation of measured sizes of many particles as cumulative percentage volume versus size. When the metal particles are flakes, the volume-average particle diameter D50 is that determined based on the shape and size of the metal particles assuming that they are spheres of the same volume.

Preferably, the average thickness of particles of the base-metal pigment is 30 nm less. As for the lower limit, it is preferred that the average thickness of particles of the base-metal pigment be 3 nm or more, more preferably 5 nm or more, even more preferably 7 nm or more, in particular 9 nm or more, although there is no particular lower limit. For the upper limit, it is preferred that the average thickness of particles of the base-metal pigment be 25 nm or less, more preferably 23 nm or less, even more preferably 21 nm or less, in particular 19 nm or less, in particular 17 nm or less, in particular 15 nm or less. When having an average thickness of particles in these ranges, the base-metal pigment tends to have enhanced leafing properties and better luster.

The average thickness of particles of the base-metal pigment can be measured using an atomic force microscope (AFM). Any measuring technology can be used, but an example is atomic force microscopy using NanoNavi E-Sweep (SII NanoTechnology). For example, the thickness of any 50 particles of the base-metal pigment is measured, and the measurements are averaged. That is, it is preferred that the average thickness be an arithmetic mean thickness.

### 1.2 Dispersant(s)

The pigment composition according to this embodiment contains at least one dispersant.

### 1.2.1 Amine Compound Having a Polyester Structure

The dispersant contained in the pigment composition according to this embodiment includes an amine compound having a polyester structure.

The “amine compound” can be any compound having one or more amine moieties in its molecular structure. An amine is a primary, secondary, or tertiary amine or its salt or other derivative and may be a quaternary ammonium salt. Preferably, the amine compound has many amine moieties. Preferably, the amine compound has a polyamine structure formed by many amine moieties.

The “polyester structure” can be any polymer structure having an ester bond. For example, it may be a polymer structure obtained through polycondensation between a diol, such as terephthalic acid, and a dicarboxylic acid, such as 1,4-butanediol, or hydroxycarboxylic acid, such as p-hydroxybenzoic acid, or may be a polymer structure obtained through ring-opening polymerization of a cyclic ester, such as a lactone.

In the context of a “polyester structure” herein, a polymer structure obtained through ring-opening polymerization of a lactone is referred to as a “polylactone structure.”

Preferably, the amine compound having a polyester structure is an amine compound having a polylactone structure, more preferably an amine compound having a polymer structure obtained through ring-opening polymerization of ε-caprolactone (polycaprolactone structure). Such a compound helps make the pigment composition particularly superior in dispersion with the specific surface treatment agent, luster, and water resistance.

Commercially available amine compounds having a polycaprolactone structure can also be used. Examples include Lubrizol SOLPLUS® D510, Lubrizol SOLSPEPSE® 39000, Lubrizol SOLSPERSE® 38500, Lubrizol SOLSPERSE® 32000, and Lubrizol SOLSPERSE® 24000.

The amine compound having a polyester structure may further have a substituent. Examples of substituents include hydroxy, alkoxy, carboxyl, carbonyl, amino, amino, pyrrolidone, cyano, azo, thiol, sulfa, and nitro groups and halogens. Of these, it is particularly preferred that the amine compound have an acidic group, such as a hydroxy, carboxyl, or sulfo group, or basic group, such as an amino, imino, or pyrrolidone group, as a substituent.

Preferably, the weight-average molecular weight (Mw) of the amine compound having a polyester structure is from 3000 to 100,000, more preferably from 10,000 to 80,000. For the lower limit, it is more preferred that the Mw be 4000 or more, even more preferably 5000 or more, still more preferably 10,000 or more, in particular 30,000 or more, in particular 40,000 or more, in particular 50,000 or more. As for the lower limit, it is more preferred that the Mw be 90,000 or less, even more preferably 80,000 or less, in particular 70,000 or less, although there is no particular upper limit. When this weight-average molecular weight is in these ranges, dispersibility is even better because this situation involves a relatively great steric hindrance. The weight-average molecular weight can be determined by known measuring methods, such as polystyrene-based gel permeation chromatography (GPO).

The weight-average molecular weight of the amine compound. having a polyester structure can be adjusted by changing parameters in the synthesis of the compound (the monomers and their amounts, heating conditions, the catalyst and its amount, etc.).

Preferably, the amine compound having a polyester structure has an acid number of 5 to 80 mg KOH/g and an amine number of 5 to 80 mg KOH/g. More preferably, the acid number is from 10 to 60 mg KOH/g, even more preferably from 20 to 50 mg KOH/g, in particular from 25 to 45 mg KOH/g, in particular from 30 to 40 mg KOH/g. As for the amine number, it is more preferred that it be from 20 to 75 mg KOH/g, even more preferably from 30 to 70 mg KOH/q, in particular from 35 to 65 mg KOH/g, in particular from 40 to 60 mg KOH/g, in particular from 45 to 55 mg KOH/g. A configuration in which the acid and amine numbers are in these ranges helps achieve better dispersibility because in that case higher solubility of the amine compound in the aqueous composition leads to enhanced compatibility. For the same reason, it is more preferred chat the amine number be greater than the acid number, preferably higher than the acid number by 5 or more, more preferably higher than the acid number by 10 or more, even more preferably higher than the acid number by 12 or more. Still more preferably, the amine number is higher than the acid number by 13 to 20.

The acid and amine numbers can be measured by the methods specified in JIS K 2501. The amine number represents the number of milligrams (mg) of potassium hydroxide (KOH) equivalent to the amount. of hydrochloric acid or perchloric acid required to neutralize basic components contained in 1 g of the sample.

The acid and amine numbers can be adjusted by changing the acidic or basic group introduced into the amine compound having a polyester structure and/or the amount of the group or by changing the monomers used to synthesize the amine compound, their amounts, and/or their proportions. For example, the acid and amine numbers can be changed by customizing a polycarboxylic acid and a polyamine used to synthesize the amine compound and/or their amounts.

Preferably, the amount of the amine compound having a polyester structure is from 0.1% to 50% by mass, more preferably from 1% to 45% by mass, even more preferably from 5% to 40% by mass, in particular from 10% to 35% by mass, in particular from 15% to 30% by mass, in particular from 20% to 25% by mass, with the amount of the metal particles being 100% by mass. A configuration in which the mass of the amine compound in these ranges helps achieve a good balance between the improvement of dispersibility and luster.

For the same reason, it is preferred that the amount of the amine compound having a polyester structure be from 0.01% to 1.00% by mass, more preferably from 0.05% to 0.80% by mass, even more preferably from. 0.10% to 0.60% by mass, in particular from 0.15% to 0.40% by mass, in particular from 0.20% to 0.30% by mass, with the amount of the pigment composition being 100% by mass.

### Synthesis

The amine compound having a polyester structure can be synthesized by known methods. An example of a synthetic process is to allow a lactone or other cyclic ester to react with a polyamine. This reaction is easy to carry out; it can be done by heating a mixture of the lactone or cyclic ester and the polyamine for a certain period of time. The temperature to which the mixture is heated is not critical, but preferably, it is from 50° C. to 200° C. for example, more preferably from 75° C. to 160° C., even more preferably from 80° C. to 120° C. The duration of heating is not critical either, but preferably, it is from 0.5 to 6 hours for example, more preferably from 1 to 4 hours, even more preferably from 2 to 3 hours. The reaction may involve a catalyst, such as an acid catalyst (e.g., p-toluenesulfonic acid), amine catalyst, or organometallic catalyst, and/or a solvent.

Examples of cyclic esters include cyclic esters (lactones) such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-hepanolactone, γ-heptanolactone, δ-heptanolactone, ε-heptanolactone, γ-octanolactone, δ-octanolactone, ε-octanolactone, δ-nonalactone, ε-nonalactone, and ε-decanolactone and compounds derived from them by replacing hydrogen(s) in the methylene group adjacent to the carbonyl group with an alkyl group having one to four carbon atoms.

The polyamine can be any compound having two or more amino functionalities. Examples of polyamines include aliphatic diamines and aromatic diamines. Specific examples of polyamines include aliphatic diamines such as ethylenediamine, propylenediamine, 2,2-dimethyl-1,3-propanediamine, 2-methyl-1,5-pentanediamine, trimethylhexanediamine, 2-butyl-2-ethyl-1,5-pentanediamine, 1,8-octanediamine, 1,9-nonanediamine, 1,10-decanediamine, isophoronediamine, and bicycloheptanedimethanamine, diethylenetriamine, hexylenediamine, triethylenetetramine, tetraethylenepentamine, xylylenediamine, diphenylmethanediamine, hydrogenated diphenylmethanediamine, hydrazine, polyamide-polyamines, polyethylene-polyimines, 1-amino-3-aminomethyl-3,5,5-trimethylcyclohexane, dicyclohexylmethanediamine, bicycloheptanedimethanamine, menthenediamine, diaminodicyclohexylmethane, isopropylidenecyclohexyl-4,4′-diamine, 1,4-diaminocyclohexane, and 1,3-bisaminomethylcyclohexane.

An amine compound having a polyester structure with an acidic group, too, can be synthesized by known methods. Examples include (i) allowing a polycarboxylic acid to react with a polymer synthesized from a lactone or other cyclic ester and a polyamine (lactone-polyamine copolymer), (ii) allowing a polyamine to react with a polymer synthesized from a lactone or other cyclic ester and a polycarboxylic acid (lactone-polycarboxylic acid copolymer), and (iii) allowing a polymer synthesized from a lactone or other cyclic ester and a polyamine (lactone-polyamine copolymer) and a polymer synthesized from a lactone or other cyclic ester and a polycarboxylic acid (lactone-polycarboxylic acid copolymer) to react together.

The reaction between the lactone or cyclic ester or lactone copolymer and the polycarboxylic acid or polycarboxylic acid copolymer is easy to carry out. An example of a process is to mix the lactone or cyclic ester or lactone copolymer and the polycarboxylic acid or polycarboxylic acid copolymer together and heat the mixture for a certain period of time while removing water. The temperature to which the mixture is heated is non critical, but preferably, it is from 100° C. to 250° C., more preferably from 120° C. to 200° C., even more preferably from 130° C. to 180° C. The duration of heating is not critical either, but preferably, it is from 1 to 10 hours, more preferably from 2 to 6 hours, even more preferably from 2 to 3 hours. The reaction may involve a catalyst, such as an acid catalyst (e.g., p-toluenesulfonic acid), amine catalyst, or organometallic catalyst, and/or a solvent.

The polycarboxylic acid can be any compound having two or more carboxyl functionalities. Specific examples of polycarboxylic acids include oxalic acid, succinic acid, tartaric acid, malic acid, citric acid, phthalic acid, isophthalic acid, terephthalic acid, 2,6-naphthalenedicarboxylic acid, and adipic acid.

### 1.2.2 Other Dispersants

The pigment composition according to this embodiment may contain dispersants other than the amine compound having a polyester structure. Examples of such dispersants include resin dispersants and polyoxyalkylene amine compounds, excluding amine compounds having a polyester structure.

Examples of resin dispersants include water-soluble resins, including (meth)acrylic resins and their salts, such as poly(meth)acrylic acid, (meth)acrylic acid-acrylonitrile copolymers, (meth)acrylic acid-(meth)acrylate copolymers, vinyl acetate-(meth)acrylate copolymers, vinyl acetate-(meth)acrylic acid copolymers, and vinyl naphthalene-(meth)acrylic acid copolymers; styrene resins and their salts, such as styrene-(meth) acrylic acid copolymers, styrene-(meth)acrylic acid-(meth)acrylate copolymers, styrene-α-methylstyrene-(meth)acrylic acid copolymers, styrene-α-methylstyrene-(meth)acrylic acid-(meth)acrylate copolymers, styrene-maleic acid copolymers, and styrene-maleic anhydride copolymers; urethane resins (i.e., polymeric compounds (resins) having a urethane bond, which is formed when an isocyanate group reacts with a hydroxyl group), whether linear-chain or branched and whether crosslinked or not, and their salts; polyvinyl alcohols; vinyl naphthalene-maleic acid copolymers and their salts; vinyl acetate-maleate copolymers and their salts; and vinyl acetate-crotonic acid copolymers and their salts.

Examples of polyoxyalkylene amine compounds include amine compounds having a polyoxyalkylene structure in their molecule. Examples of commercially available polyoxyalkylene amine compounds include JEFFAMINE M2070 (Huntsman) and GENAMIN (M41/2000) (Clariant).

### 1.3 Water

The pigment composition according to this embodiment is an aqueous composition, a composition containing water as a solvent. As used herein, the term “aqueous” means the water content of the composition is 20% by mass or more of the liquid medium component in the composition. Preferably, the water content in relation to the liquid medium component is from 30% to 100% by mass, more preferably from 40% to 90% by mass, even more preferably from 50% to 80% by mass. A liquid medium is a solvent ingredient, such as water or an organic solvent.

Preferably, he water content in relation to the pigment composition, the amount of which is 100% by mass, is 20% by mass or more, more preferably from 30% to 99% by mass, even more preferably from 40% to 90% by mass, still more preferably from 50% to 80% by mass.

Preferably, the water is purified water or ultrapure water, such as deionized water, ultrafiltered water, reverse osmosis water, or distilled water. A sterilized form of these kinds of water, for example sterilized by ultraviolet irradiation or adding hydrogen peroxide, is particularly preferred because it helps control the development of molds and bacteria for a prolonged period of time.

### 1.4 Organic Solvent(s)

The pigment composition according to this embodiment may contain organic solvents as solvents. Examples of organic solvents include esters, alkylene glycol ethers, cyclic esters, nitrogen-containing solvents, alcohols, and polyhydric alcohols. Examples of nitrogen-containing solvents include cyclic amides and acyclic amides, Examples of acyclic amides include alkoxyalkylamides.

Examples of esters include glycol monoacetates, such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxybutyl acetate, and glycol diesters, such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, diethylene glycol acetate butyrate, propylene glycol acetate propionate, propylene glycol acetate butyrate, dipropylene glycol acetate butyrate, and dipropylene glycol acetate propionate.

The alkylene glycol ethers include any monoether or diether of an alkylene glycol, and alkyl ethers are preferred. Specific examples include alkylene glycol monoalkyl ethers, such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, and tripropylene glycol monobutyl ether, and alkylene glycol dialkyl ethers, such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

For these alkylene glycols, diethers are preferred to monoethers because their strong tendency to dissolve or swell resins, optionally contained in the composition, helps further improve abrasion resistance.

Examples of cyclic esters are not listed here; they are the same as listed above.

Examples of alkoxyalkylamides include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-isopropoxy-N,N-dimethylpropionamide, 3-isopropoxy-N,N-diethylpropionamide, 3-isopropoxy-N,N-methylethylpropionamide, 3-tert-butoxy-N,N-dimethylpropionamide, 3-tert-butoxy-N,N-diethylpropionamide, and 3-tert-butoxy-N,N-methylethylpropionamide.

Examples of cyclic amides include lactams, such as pyrrolidones including 2-pyrrolidone, 1-methyl-2-pyrrolidone, 1-ethyl-2-pyrrolidone, 1-propyl-2-pyrrolidone, and 1-butyl-2-pyrrolidone. These are preferred because they accelerate film formation by resins. In particular, 2-pyrrolidone is preferred to the others.

An example of an alcohol is a compound derived from an alkane by replacing one of its hydrogen atoms with a hydroxyl group. Preferably, the alkane has ten or fewer carbon atoms, more preferably six or fewer, even more preferably three or fewer. The number of carbon atoms in the alkane is one or more, preferably two or more. The alkane may be linear-chain or may be branched. Examples of alcohols include methanol, ethanol, n-propyl alcohol, isopropyl alcohol, n-butanol, 2-butanol, tert-butanol, isobutanol, n-pentanol, 2-pentanol, 3-pentanol, and tert-pentanol as well as 2-phenoxyethanol, benzyl alcohol, and phenoxypropanol.

When the pigment composition contains alcohol(s), it is more preferred that the alcohol(s) be selected from aromatic monohydric alcohols and aliphatic monohydric alcohols having four or more carbon atoms. Although soluble in water, such alcohols are highly compatible with specific surface treatment agents, at least one of which is used to treat the surface of the metal particles, by virtue of being somewhat hydrophobic and, therefore, tend to help further improve the dispersbility of the base-metal pigment in the aqueous pigment composition.

An aromatic monohydric alcohol is a monohydric alcohol having an aromatic ring, and examples of aromatic rings include the benzene ring and the naphthalene ring system. For the aromatic monohydric alcohols, it is preferred that the hydroxyl group be bound to an alkylene backbone having one to four carbon atoms, more preferably that having one to three carbon atoms.

As for aliphatic monohydric alcohols having four or more carbon atoms, those having four to ten carbon atoms are preferred, and those having four to eight carbon atoms are more preferred.

Preferably, the (total) amount of the aromatic monohydric alcohol(s) and/or aliphatic monohydric alcohol(s) having four or more carbon atoms is 0.5% by mass or more, more preferably 1% by mass or more, in particular 3% by mass or more of the total mass of the pigment composition. Preferably, furthermore, the amount of the aromatic monohydric alcohol(s) and/or aliphatic monohydric alcohol(s) having four or more carbon atoms is 40% by mass or less, preferably 30% by mass or less, more preferably 20% by mass or less, in particular 10% by mass or less.

It is also preferred that the amount of the aromatic monohydric alcohol(s) and/or aliphatic monohydric alcohol(s) having four or more carbon atoms be in these ranges with respect to the total mass of the liquid medium component in the pigment composition.

Polyhydric alcohols are alcohols having two or more hydroxyl groups in their molecule. Polyhydric alcohols can be divided into, for example, alkanediols and polyols.

An alkanediol for example, a compound in which an alkane is substituted with two hydroxyl groups. Examples of alkane dials include ethylene glycol (also known as ethane-1,2-diol), propylene glycol (also known as propane-1,2-diol), 1,2-butanediol, 1,2-pentanediol, 1,2-hexanediol, 1,2-octanediol, 1,3-propanediol, 1,3-butylene glycol (also known as 1,3-butanediol), 1,4-butanediol, 2,3-butanediol, 1,2-pentanediol, 1,5-pentanediol, 2,4-pentanediol, 2-methyl-1,3-propanediol, 3-methyl-1,3-butanediol, 3-methyl-1,5-pentanedial, 2-ethyl-1,3-hexanediol, 2-methyl-1,3-pentanediol, 3-methyl-1,5-pentanediol, 2-methylpentane-2,4-dial, 1,6-hexanediol, 2-ethyl-2-methyl-1,3-propanediol, and 2-methyl-2-propyl-1,3-propanediol.

Examples of polyols include condensates in which two or more alkanediol molecules have undergone intermolecular condensation at their hydroxyl groups, and also include compounds having three or more hydroxyl groups.

Examples of condensates in which two or more alkanediol molecules have undergone intermolecular condensation at their hydroxyl groups include dialkylene glycols, such as diethylene glycol and dipropylene glycol, and trialkylene glycols, such as triethylene glycol and tripropylene glycol.

A compound having three or more hydroxyl groups is a compound having an alkane or polyether structure, for example, as its backbone and three or more hydroxyl groups on it. Examples of compounds having three or more hydroxyl groups include glycerol, trimethylolethane, trimethylolpropane, 1,2,5-hexanetriol, 1,2,6-hexanetriol, pentaerythritol, and polyoxypropylenetriol.

Preferably, the polyhydric alcohol content is from 1% to 40% by mass, more preferably from 3% to 35% by mass, even more preferably from 10% to 30% by mass of the total mass of the pigment composition.

One of these organic solvents may be used alone, or two or more may be used in combination.

Preferably, the organic solvent content is 1% by mass or more, more preferably 5% by mass or more, in particular 10% by mass or more of the total mass of the pigment composition. More preferably, the organic solvent content is 20% by mass or more, even more preferably 30% by mass or more.

As for the upper limit, it. is preferred that the organic solvent content be 60% by mass or less, preferably 50% by mass or less, more preferably 40% by mass or less.

It is also preferred that the organic solvent content be in these ranges with respect to the total mass of the liquid medium component in the pigment composition.

### 1.5 Extra Ingredients

The pigment composition according to this embodiment may contain ingredients other than those described above. Examples of such ingredients include leveling agents, binders, polymerization accelerators, polymerization inhibitors, photopolymerization initiators, surfactants, penetration enhancers, humectants, coloring agents, fixatives, antimolds, preservatives, antioxidants, chelating agents, thickeners, sensitizers, etc.

A binder only needs to be a resin, but examples of preferred resins include acrylic resins, polyester resins, urethane resins, and cellulose resins. An acrylic resin is a resin obtained by polymerizing at least an acrylic monomer and may be a copolymer resin formed by an acrylic monomer and an extra monomer. An example of an extra monomer is a vinyl monomer.

Examples of preferred surfactants include silicone surfactants and acetylene glycol surfactants.

### 2. Coloring Method

A coloring method according to an embodiment of the present disclosure includes attaching a coloring composition to a substrate. The pigment composition described above is the coloring composition.

With the coloring method according to this embodiment, in which the coloring composition used is the pigment composition described above, dispersibility and the luster of the colored article are good.

The shape of the substrate is not critical; it may be a sheet or plate or may be art object in any other shape. The material for the substrate is also at the discretion of the one who carries out the method; examples include paper, fabric, plastic materials, metals, glass, ceramics, and wood. It should be noted that the substrate can be anything that can be colored; it does not need to be a recording medium.

It is not critical how the coloring composition is attached to the substrate either; the composition can be attached by, for example, brush coating, roller coating, spray coating, bar coating, or ink jet attachment. The viscosity and other characteristics of the coloring composition can be selected by changing the ingredients, their concentrations, etc., according to the attachment method.

The coloring method may include, for example, pretreatment and drying steps, in which the substrate is pretreated and dried, respectively. The presence of such steps can make the luster of the colored article better.

### 3. Examples

Aspects of the present disclosure will now be described in further detail by providing examples. No aspect of the present disclosure, however, is limited to these examples. In the following, “%” is by mass unless stated otherwise.

### 3.1 Synthesis of Dispersants

Of the dispersants listed in Tables 1 to 7 polylactone-amines 1 to 6 and the polyester polycarboxylic acid were synthesized as follows.

### Polylactone-Amine 1

A mixture of 159 g of ε-caprolactone and 21 g of succinic acid was stripped of water by placing it under reduced pressure for 1 hour at 8000. The mixture was heated to 160° C., 0.9 g of p-toluenesulfonic acid as a catalyst wax mixed thereinto, and the resulting mixture was heated for 2 hours. This gave a polycarboxylic acid-modified caprolactone polymer.

Then 88.2 g of the polycarboxylic acid-modified caprolactone polymer was mixed into 11.8 g of tetraethylenepentamine, and the resulting mixture was heated for 2 hours at 80° C. This bound the polycarboxylic acid-modified caprolactone polymer and the tetraethylenepentamine together, yielding a polyamine-polycarboxylic acid-modified caprolactone polymer.

The acid number, amine number, and volume-average molecular weight of the polyamine-polycarboxylic acid-modified caprolactone polymer were measured. Then polylactone-amine 1 was obtained by adjusting the amounts of the ε-caprolactone, succinic acid, and tetraethylenepentamine in the respective steps to make the acid number 35 mg KOH/g, the amine number 50 mg KOH/g, and the volume-average molecular weight 60,000.

### Polylactone-Amines 2 to 6

Polylactone-amines 2 to 6 were obtained by adjusting the amounts of the ε-caprolactone, succinic acid, and tetraethylenepentamine in the respective steps for the production of polylactone-amine 1 to make the acid number, amine number, and volume-average molecular weight as in the following list.
Polylactone-amine 2 (acid number, 45 mg KOH/g; amine number, 45 mg KOH/g; volume-average molecular weight, 60,000)

Polylactone-amine 3 (acid number, 60 mg KOH/g; amine number, 30 mg KOH/g; volume-average molecular weight, 60,000)
Polylactone-amine 4 (acid number, 35 mg KOH/g; amine number, 50 mg KOH/g; volume-average molecular weight, 5000)
Polylactone-amine 5 (acid number, 45 mg KOH/g; amine number, 45 mg KOH/g; volume-average molecular weight, 5000)
Polylactone-amine 6 (acid number, 60 mg KOH/g; amine number, 30 mg KOH/g; volume-average molecular weight, 5000)

### Polyester Polycarboxylic Acid

The carboxylic acid-terminated caprolactone polymer obtained during the synthesis of polylactone-amine 1 was used.

### 3.2 Preparation of Pigment Compositions

A release resin solubilized with acetone was coated. onto a 20-μm. PET base sheet using a roller coater to form a release layer. The PET sheet with a release layer thereon was transferred at a rate of 5 m/s to an aluminum vacuum deposition machine, where an aluminum layer was formed to a thickness of 15 nm under reduced pressure. The resulting aluminum/release resin/PET sheet workpiece was immersed in a tetrahydrofuran bath and sonicated at 40 kHz. The aluminum pigment became detached from the PET sheet, giving a liquid containing the detached aluminum pigment. After the tetrahydrofuran was removed using a centrifuge, an appropriate amount of diethylene glycol diethyl ether was added to the solids. This gave a suspension of aluminum particles containing 5% by mass aluminum.

The suspension of aluminum particles was stirred until the particles were crushed to their intended average diameter, giving a suspension of aluminum particles having an ink-jettable diameter (volume-average diameter C50=0.5 μm or less). In Examples 46 to 53, the base-metal pigment was crushed to the average particle diameter indicated in Table 7.

After this crushing step, Jeffamine M-2070, a poly(oxyethylene/oxypropylene) amine dispersant, was added to make up 5% in relation to the aluminum concentration, and the resulting mixture was heated at 55° C. for 1 hour while being sonicated at 40 kHz so that aggregates would break into dispersed primary particles of aluminum.

A surface treatment agent was added to this suspension of dispersed primary particles of aluminum in such a manner that the final percentage of the agent would be as in Tables 1 to 7 The resulting mixture was heated at 55° C. for 3 hours while being sonicated at 40 kHz, giving a dispersion of a surface-treated aluminum pigment.

The solvent was removed from the aluminum pigment dispersion by centrifugation, and a dispersant was mixed into the residue in such a manner that the final ratio by mass of the dispersant to the aluminum pigment would be that selected for the particular example or comparative example, indicated in Tables 1 to 7. As an aqueous solvent substituting for the solvent, water was mixed into the mixture to make the aluminum pigment content 20% by mass. The resulting mixture was stirred, yielding a corresponding pigment composition for that example or comparative example. This pigment composition may be used as a pigment dispersion as a composition for the preparation of a coloring composition or may be used as a coloring composition, such as paint.

Separately, the solvent removed from the dispersion of a surface-treated aluminum pigment was analyzed. In all examples and comparative examples, the solvent contained no surface treatment agent. This suggests that in the examples and comparative examples in Tables 1 to 7, the surface treatment agent was on the metal particles in the composition.

To this pigment composition, ingredients such as water and organic solvents were added according to the formula indicated in Tables 1 to 7. In this way, pigment compositions according to examples and comparative examples were obtained. These pigment compositions are coloring compositions and were subjected to the evaluations described below.

TABLE 1

| | | | Example | Example | Example | Example | Example | Example | Comparative | Comparative | Comparative |
|---|---|---|---|---|---|---|---|---|---|---|---|
| | | | 1 | 2 | 3 | 4 | 5 | 6 | Example 1 | Example 2 | Example 3 |
| Base-metal pigment | | Particle diameter | 0.47 | 0.47 | 0.47 | 0.47 | 0.47 | 0.47 | 0.47 | 0.47 | 0.47 |
| (aluminum particles) | | D50 [μm] | | | | | | | | | |
| | | Amount | 1.20 | 1.20 | 1.20 | 1.20 | 1.20 | 1.20 | 1.20 | 1.20 | 1.20 |
| Surface | Octadecyl (C18H37) | | 0.36 | 0.36 | 0.36 | 0.36 | 0.36 | 0.36 | 0.36 | 0.36 | 0.36 |
| treatment | phosphonic acid | | | | | | | | | | |
| agent | Octadecyl (C18H37) | | | | | | | | | | |
| | phosphoric acid | | | | | | | | | | |
| | Dodecyl (C12H25) | | | | | | | | | | |
| | phosphonic acid | | | | | | | | | | |
| | Tridecyl (C13H27) | | | | | | | | | | |
| | phosphoric acid | | | | | | | | | | |
| | Dodecyl (C12H25) | | | | | | | | | | |
| | phosphoric acid | | | | | | | | | | |
| | Octyl (C8H17) | | | | | | | | | | |
| | phosphonic acid | | | | | | | | | | |
| | FHP | | | | | | | | | | |
| Dispersant | Amine | Polylactone-amine 1 | 0.24 | | | | | | | | |
| | compound | Polylactone-amine 2 | | 0.24 | | | | | | | |
| | having | Polylactone-amine 3 | | | 0.24 | | | | | | |
| | a polyester | Polylactone-amine 4 | | | | 0.24 | | | | | |
| | structure | Polylactone-amine 5 | | | | | 0.24 | | | | |
| | | Polylactone-amine 6 | | | | | | 0.24 | | | |

| | Polycarboxylic acid amine | | | | | | | 0.24 | | |
|---|---|---|---|---|---|---|---|---|---|---|
| | Polyester polycarboxylic acid | | | | | | | | 0.24 | |
| | Polyether-amine | | | | | | | | | 0.24 |
| Solvents | 1,2-Hexanediol (C6H14O2) | 30.0 | 30.0 | 30.0 | 30.0 | 30.0 | 30.0 | 30.0 | 30.0 | 30.0 |
| | 2-Phenoxy Ethanol (C8H10O2) | 5.00 | 5.00 | 5.00 | 5.00 | 5.00 | 5.00 | 5.00 | 5.00 | 5.00 |
| | Purified water | Balance | Balance | Balance | Balance | Balance | Balance | Balance | Balance | Balance |
| Total | | 100 | 100 | 100 | 100 | 100 | 100 | 100 | 100 | 100 |
| Evaluations | Dispersibility | A | B | C | B | B | C | D | D | D |
| | Luster | A | A | B | A | A | B | D | C | D |
| | Water resistance | A | A | B | A | B | B | E | D | E |

TABLE 2

| | | | Ex- | Ex- | Ex- | Ex- | Ex- | Ex- | Ex- | Ex- | Ex- | Ex- | Ex- | Ex- |
|---|---|---|---|---|---|---|---|---|---|---|---|---|---|---|
| | | | ample | ample | ample | ample | ample | ample | ample | ample | ample | ample | ample | ample |
| | | | 7 | 8 | 9 | 10 | 11 | 12 | 13 | 14 | 15 | 16 | 17 | 18 |
| Base-metal | | Particle | 0.47 | 0.47 | 0.47 | 0.47 | 0.47 | 0.47 | 0.47 | 0.47 | 0.47 | 0.47 | 0.47 | 0.47 |
| pigment | | diameter | | | | | | | | | | | | |
| (aluminum | | D50 [μm] | | | | | | | | | | | | |
| particles) | | Amount | 1.20 | 1.20 | 1.20 | 1.20 | 1.20 | 1.20 | 1.20 | 1.20 | 1.20 | 1.20 | 1.20 | 1.20 |
| Surface | Octadecyl (C18H37) | | | | | | | | | | | | | |
| treat- | phosphonic acid | | | | | | | | | | | | | |
| ment | Octadecyl (C18H37) | | 0.36 | 0.36 | 0.36 | 0.36 | 0.36 | 0.36 | | | | | | |
| agent | phosphoric acid | | | | | | | | | | | | | |
| | Dodecyl (C12H25) | | | | | | | | 0.36 | 0.36 | 0.36 | 0.36 | 0.36 | 0.36 |
| | phosphonic acid | | | | | | | | | | | | | |
| | Tridecyl (C13H27) | | | | | | | | | | | | | |
| | phosphoric acid | | | | | | | | | | | | | |
| | Dodecyl (C12H25) | | | | | | | | | | | | | |
| | phosphoric acid | | | | | | | | | | | | | |
| | Octyl (C8H17) | | | | | | | | | | | | | |
| | phosphonic acid | | | | | | | | | | | | | |
| | FHP | | | | | | | | | | | | | |
| Dis- | Amine | Polylactone- | 0.24 | | | | | | 0.24 | | | | | |
| persant | compound | amine 1 | | | | | | | | | | | | |
| | having a | Polylactone- | | 0.24 | | | | | | 0.24 | | | | |
| | polyester | amine 2 | | | | | | | | | | | | |
| | structure | Polylactone- | | | 0.24 | | | | | | 0.24 | | | |
| | | amine 3 | | | | | | | | | | | | |
| | | Polylactone- | | | | 0.24 | | | | | | 0.24 | | |
| | | amine 4 | | | | | | | | | | | | |
| | | Polylactone- | | | | | 0.24 | | | | | | 0.24 | |
| | | amine 5 | | | | | | | | | | | | |
| | | Polylactone- | | | | | | 0.24 | | | | | | 0.24 |
| | | amine 6 | | | | | | | | | | | | |

| | Polycarboxylic acid | | | | | | | | | | | | |
|---|---|---|---|---|---|---|---|---|---|---|---|---|---|
| | amine | | | | | | | | | | | | |
| | Polyester | | | | | | | | | | | | |
| | polycarboxylic acid | | | | | | | | | | | | |
| | Polyether-amine | | | | | | | | | | | | |
| Sol- | 1,2-Hexanediol | 30.0 | 30.0 | 30.0 | 30.0 | 30.0 | 30.0 | 30.0 | 30.0 | 30.0 | 30.0 | 30.0 | 30.0 |
| vents | (C6H14O2) | | | | | | | | | | | | |
| | 2-Phenoxy Ethanol | 5.00 | 5.00 | 5.00 | 5.00 | 5.00 | 5.00 | 5.00 | 5.00 | 5.00 | 5.00 | 5.00 | 5.00 |
| | (C8H10O2) | | | | | | | | | | | | |
| | Purified water | Bal- | Bal- | Bal- | Bal- | Bal- | Bal- | Bal- | Bal- | Bal- | Bal- | Bal- | Bal- |
| | | ance | ance | ance | ance | ance | ance | ance | ance | ance | ance | ance | ance |
| Total | | 100 | 100 | 100 | 100 | 100 | 100 | 100 | 100 | 100 | 100 | 100 | 100 |
| Eval- | Dispersibility | A | B | C | A | B | C | B | C | C | B | B | C |
| uations | Luster | A | A | B | A | A | B | A | A | C | A | B | C |
| | Water resistance | B | B | C | B | C | C | B | B | C | B | C | C |

TABLE 3

| | | | Ex- | Ex- | Ex- | Ex- | Ex- | Ex- | Ex- | Ex- | Ex- | Ex- | Ex- | Ex- |
|---|---|---|---|---|---|---|---|---|---|---|---|---|---|---|
| | | | ample | ample | ample | ample | ample | ample | ample | ample | ample | ample | ample | ample |
| | | | 19 | 20 | 21 | 22 | 23 | 24 | 25 | 26 | 27 | 28 | 29 | 30 |
| Base-metal | | Particle | 0.47 | 0.47 | 0.47 | 0.47 | 0.47 | 0.47 | 0.47 | 0.47 | 0.47 | 0.47 | 0.47 | 0.47 |
| pigment | | diameter | | | | | | | | | | | | |
| (aluminum | | D50 [μm] | | | | | | | | | | | | |
| particles) | | Amount | 1.20 | 1.20 | 1.20 | 1.20 | 1.20 | 1.20 | 1.20 | 1.20 | 1.20 | 1.20 | 1.20 | 1.20 |
| Sur- | Octadecyl (C18H37) | | | | | | | | | | | | | |
| face | phosphoric acid | | | | | | | | | | | | | |
| treat- | Octadecyl (C18H37) | | | | | | | | | | | | | |
| ment | phosphoric acid | | | | | | | | | | | | | |
| agent | Dodecyl (C12H25) | | | | | | | | | | | | | |
| | phosphonic acid | | | | | | | | | | | | | |
| | Tridecyl (C13H27) | | 0.36 | 0.36 | 0.36 | 0.36 | 0.36 | 0.36 | | | | | | |
| | phosphoric acid | | | | | | | | | | | | | |
| | Dodecyl (C12H25) | | | | | | | | 0.36 | 0.36 | 0.36 | 0.36 | 0.36 | 0.36 |
| | phosphoric acid | | | | | | | | | | | | | |
| | Octyl (C8H17) | | | | | | | | | | | | | |
| | phosphonic acid | | | | | | | | | | | | | |
| | FHP | | | | | | | | | | | | | |
| Dis- | Amine | Polylactone- | 0.24 | | | | | | 0.24 | | | | | |
| per- | compound | amine 1 | | | | | | | | | | | | |
| sant | having a | Polylactone- | | 0.24 | | | | | | 0.24 | | | | |
| | polyester | amine 2 | | | | | | | | | | | | |
| | structure | Polylactone- | | | 0.24 | | | | | | 0.24 | | | |
| | | amine 3 | | | | | | | | | | | | |
| | | Polylactone- | | | | 0.24 | | | | | | 0.24 | | |
| | | amine 4 | | | | | | | | | | | | |
| | | Polylactone- | | | | | 0.24 | | | | | | 0.24 | |
| | | amine 5 | | | | | | | | | | | | |
| | | Polylactone- | | | | | | 0.24 | | | | | | 0.24 |
| | | amine 6 | | | | | | | | | | | | |

| | Polycarboxylic acid | | | | | | | | | | | | |
|---|---|---|---|---|---|---|---|---|---|---|---|---|---|
| | amine | | | | | | | | | | | | |
| | Polyester | | | | | | | | | | | | |
| | polycarboxylic acid | | | | | | | | | | | | |
| | Polyether-amine | | | | | | | | | | | | |
| Sol- | 1,2-Hexanediol | 30.0 | 30.0 | 30.0 | 30.0 | 30.0 | 30.0 | 30.0 | 30.0 | 30.0 | 30.0 | 30.0 | 30.0 |
| vents | (C6H14O2) | | | | | | | | | | | | |
| | 2-Phenoxy Ethanol | 5.00 | 5.00 | 5.00 | 5.00 | 5.00 | 5.00 | 5.00 | 5.00 | 5.00 | 5.00 | 5.00 | 5.00 |
| | (C8H10O2) | | | | | | | | | | | | |
| | Purified water | Bal- | Bal- | Bal- | Bal- | Bal- | Bal- | Bal- | Bal- | Bal- | Bal- | Bal- | Bal- |
| | | ance | ance | ance | ance | ance | ance | ance | ance | ance | ance | ance | ance |
| Total | | 100 | 100 | 100 | 100 | 100 | 100 | 100 | 100 | 100 | 100 | 100 | 100 |
| Eval- | Dispersibility | B | C | C | B | B | C | B | C | C | C | C | C |
| ua- | Luster | B | B | C | B | C | C | B | B | C | B | C | C |
| tions | Water resistance | B | B | C | B | C | C | C | C | C | C | C | C |

TABLE 4

| | | | Com- | Com- | Com- | Com- | Com- | Com- | Com- | Com- | Com- | Com- | Com- | Com- |
|---|---|---|---|---|---|---|---|---|---|---|---|---|---|---|
| | | | para- | para- | para- | para- | para- | para- | para- | para- | para- | para- | para- | para- |
| | | | tive | tive | tive | tive | tive | tive | tive | tive | tive | tive | tive | tive |
| | | | Example 4 | Example 5 | Example 6 | Example 7 | Example 8 | Example 9 | Example 10 | Example 11 | Example 12 | Example 13 | Example 14 | Example 15 |
| Base-metal pigment | | Particle diameter D50 | 0.47 | 0.47 | 0.47 | 0.47 | 0.47 | 0.47 | 0.47 | 0.47 | 0.47 | 0.47 | 0.47 | 0.47 |
| (aluminum particles) | | [μm] | | | | | | | | | | | | |
| | | Amount | 1.20 | 1.20 | 1.20 | 1.20 | 1.20 | 1.20 | 1.20 | 1.20 | 1.20 | 1.20 | 1.20 | 1.20 |
| Surface | Octadecyl (C18H37) phosphonic | | | | | | | | | | | | | |
| treatment | acid | | | | | | | | | | | | | |
| agent | Octadecyl (C18H37) phosphoric | | | | | | | | | | | | | |
| | acid | | | | | | | | | | | | | |
| | Dodecyl (C12H25) phosphonic | | | | | | | | | | | | | |
| | acid | | | | | | | | | | | | | |
| | Tridecyl (C13H27) phosphoric | | | | | | | | | | | | | |
| | acid | | | | | | | | | | | | | |
| | Dodecyl (C12H25) phosphoric | | | | | | | | | | | | | |
| | acid | | | | | | | | | | | | | |
| | Octyl (C8H17) phosphonic acid | | 0.36 | 0.36 | 0.36 | 0.36 | 0.36 | 0.36 | | | | | | |
| | FHP | | | | | | | | 0.36 | 0.36 | 0.36 | 0.36 | 0.36 | 0.36 |
| Dispersant | Amine | Polylactone-amine 1 | 0.24 | | | | | | 0.24 | | | | | |
| | compound | Polylactone-amine 2 | | 0.24 | | | | | | 0.24 | | | | |
| | having a | Polylactone-amine 3 | | | 0.24 | | | | | | 0.24 | | | |
| | polyester | Polylactone-amine 4 | | | | 0.24 | | | | | | 0.24 | | |
| | structure | Polylactone-amine 5 | | | | | 0.24 | | | | | | 0.24 | |
| | | Polylactone-amine 6 | | | | | | 0.24 | | | | | | 0.24 |

| | Polycarboxylic acid amine | | | | | | | | | | | | |
|---|---|---|---|---|---|---|---|---|---|---|---|---|---|
| | Polyester polycarboxylic acid | | | | | | | | | | | | |
| | Polyether-amine | | | | | | | | | | | | |
| Solvents | 1,2-Hexanediol (C6H14O2) | 30.0 | 30.0 | 30.0 | 30.0 | 30.0 | 30.0 | 30.0 | 30.0 | 30.0 | 30.0 | 30.0 | 30.0 |
| | 2-Phenoxy Ethanol (C8H10O2) | 5.00 | 5.00 | 5.00 | 5.00 | 5.00 | 5.00 | 5.00 | 5.00 | 5.00 | 5.00 | 5.00 | 5.00 |
| | Purified water | Balance | Balance | Balance | Balance | Balance | Balance | Balance | Balance | Balance | Balance | Balance | Balance |
| Total | | 100 | 100 | 100 | 100 | 100 | 100 | 100 | 100 | 100 | 100 | 100 | 100 |
| Evaluations | Dispersibility | D | D | D | D | D | D | D | D | D | D | D | D |
| | Luster | C | C | D | C | D | D | C | D | D | D | D | D |
| | Water resistance | D | D | E | D | D | E | C | C | D | C | C | D |

TABLE 5

| | | | Example | Example | Example | Example | Example | Example | Example |
|---|---|---|---|---|---|---|---|---|---|
| | | | 31 | 32 | 33 | 34 | 35 | 36 | 37 |
| Base-metal pigment | | Particle diameter | 0.47 | 0.47 | 0.47 | 0.47 | 0.47 | 0.47 | 0.47 |
| (aluminum particles) | | D50 [μm]] | | | | | | | |
| | | Amount | 1.20 | 1.20 | 1.20 | 1.20 | 1.20 | 1.20 | 1.20 |
| Surface | Octadecyl (C18H37) | | 0.72 | | 0.18 | | 0.36 | 0.36 | 0.36 |
| treatment | phosphonic acid | | | | | | | | |
| agent | Octadecyl (C18H37) | | | 0.72 | | 0.18 | | | |
| | phosphoric acid | | | | | | | | |
| | Dodecyl (C12H25) | | | | | | | | |
| | phosphonic acid | | | | | | | | |
| | Tridecyl (C13H27) | | | | | | | | |
| | phosphoric acid | | | | | | | | |
| | Dodecyl (C12H25) | | | | | | | | |
| | phosphoric acid | | | | | | | | |
| | Octyl (C8H17) phosphonic | | | | | | | | |
| | acid | | | | | | | | |
| | FHP | | | | | | | | |
| Dispersant | Amine | Polylactone- | 0.24 | 0.24 | 0.24 | 0.24 | 0.24 | 0.24 | 0.24 |
| | compound | amine 1 | | | | | | | |
| | having a | Polylactone- | | | | | | | |
| | polyester | amine 2 | | | | | | | |
| | structure | Polylactone- | | | | | | | |
| | | amine 3 | | | | | | | |
| | | Polylactone- | | | | | | | |
| | | amine 4 | | | | | | | |
| | | Polylactone- | | | | | | | |
| | | amine 5 | | | | | | | |
| | | Polylactone- | | | | | | | |
| | | amine 6 | | | | | | | |

| | Polycarboxylic acid amine | | | | | | | |
|---|---|---|---|---|---|---|---|---|
| | Polyester polycarboxylic acid | | | | | | | |
| | Polyether-amine | | | | | | | |
| Solvents | 1,2-Hexanediol (C6H14O2) | 30.0 | 30.0 | 30.0 | 30.0 | 5.0 | 35.0 | 0.00 |
| | 2-Phenoxy Ethanol | 5.00 | 5.00 | 5.00 | 5.00 | 30.00 | 0.00 | 35.00 |
| | (C8H10O2) | | | | | | | |
| | Purified water | Balance | Balance | Balance | Balance | Balance | Balance | Balance |
| Total | | 100 | 100 | 100 | 100 | 100 | 100 | 100 |
| Evaluations | Dispersibility | C | C | C | C | B | B | C |
| | Luster | C | C | C | C | B | C | B |
| | Water resistance | C | C | D | D | A | B | B |

TABLE 6

| | | | Example | Example | Example | Example | Example | Example | Example | Example |
|---|---|---|---|---|---|---|---|---|---|---|
| | | | 38 | 39 | 40 | 41 | 42 | 43 | 44 | 45 |
| Base-metal pigment | | Particle | 0.47 | 0.47 | 0.47 | 0.47 | 0.47 | 0.47 | 0.47 | 0.47 |
| (aluminum particles) | | diameter D50 | | | | | | | | |
| | | [μm] | | | | | | | | |
| | | Amount | 1.20 | 1.20 | 1.20 | 1.20 | 1.20 | 1.20 | 1.20 | 1.20 |
| Surface | Octadecyl (C18H37) | | 0.36 | 0.36 | 0.36 | 0.36 | | | | |
| treatment | phosphonic acid | | | | | | | | | |
| agent | Octadecyl (C18H37) | | | | | | 0.36 | 0.36 | 0.36 | 0.36 |
| | phosphoric acid | | | | | | | | | |
| | Dodecyl (C12H25) | | | | | | | | | |
| | phosphonic acid | | | | | | | | | |
| | Tridecyl (C13H27) | | | | | | | | | |
| | phosphoric acid | | | | | | | | | |
| | Dodecyl (C12H25) | | | | | | | | | |
| | phosphoric acid | | | | | | | | | |
| | Octyl (C8H17) | | | | | | | | | |
| | phosphonic acid | | | | | | | | | |
| | FHP | | | | | | | | | |
| Dispersant | Amine | Polylactone- | 0.12 | 0.48 | | | 0.12 | 0.48 | | |
| | compound | amine 1 | | | | | | | | |
| | having a | Polylactone- | | | | | | | | |
| | polyester | amine 2 | | | | | | | | |
| | structure | Polylactone- | | | | | | | | |
| | | amine 3 | | | | | | | | |
| | | Polylactone- | | | 0.12 | 0.48 | | | 0.12 | 0.48 |
| | | amine 4 | | | | | | | | |
| | | Polylactone- | | | | | | | | |
| | | amine 5 | | | | | | | | |
| | | Polylactone- | | | | | | | | |
| | | amine 6 | | | | | | | | |

| | Polycarboxylic acid | | | | | | | | |
|---|---|---|---|---|---|---|---|---|---|
| | amine | | | | | | | | |
| | Polyester polycarboxylic | | | | | | | | |
| | acid | | | | | | | | |
| | Polyether-amine | | | | | | | | |
| Solvents | 1,2-Hexanediol | 30.0 | 30.0 | 30.0 | 30.0 | 30.0 | 30.0 | 30.0 | 30.0 |
| | (C6H14O2) | | | | | | | | |
| | 2-Phenoxy Ethanol | 5.00 | 5.00 | 5.00 | 5.00 | 5.00 | 5.00 | 5.00 | 5.00 |
| | (C8H10O2) | | | | | | | | |
| | Purified water | Balance | Balance | Balance | Balance | Balance | Balance | Balance | Balance |
| Total | | 100 | 100 | 100 | 100 | 100 | 100 | 100 | 100 |
| Evaluations | Dispersibility | B | A | B | B | B | A | B | B |
| | Luster | A | B | A | B | A | B | A | B |
| | Water resistance | A | A | A | A | B | B | B | B |

TABLE 7

| | | | Example | Example | Example | Example | Example | Example | Example | Example |
|---|---|---|---|---|---|---|---|---|---|---|
| | | | 46 | 47 | 48 | 49 | 50 | 51 | 52 | 53 |
| Base-metal (aluminum | | Particle | 7.00 | 9.00 | 7.00 | 9.00 | 7.00 | 9.00 | 7.00 | 9.00 |
| pigment particles) | | diameter D50 | | | | | | | | |
| | | [μm] | | | | | | | | |
| | | Amount | 1.20 | 1.20 | 1.20 | 1.20 | 1.20 | 1.20 | 1.20 | 1.20 |
| Surface | Octadecyl (C18H37) | | 0.36 | 0.36 | | | 0.36 | 0.36 | | |
| treatment | phosphonic acid | | | | | | | | | |
| agent | Octadecyl (C18H37) | | | | 0.36 | 0.36 | | | 0.36 | 0.36 |
| | phosphoric acid | | | | | | | | | |
| | Dodecyl (C12H25) | | | | | | | | | |
| | phosphonic acid | | | | | | | | | |
| | Tridecyl (C13H27) | | | | | | | | | |
| | phosphoric acid | | | | | | | | | |
| | Dodecyl (C12H25) | | | | | | | | | |
| | phosphoric acid | | | | | | | | | |
| | Octyl (C8H17) | | | | | | | | | |
| | phosphonic acid | | | | | | | | | |
| | FHP | | | | | | | | | |
| Dispersant | Amine | Polylactone- | 0.24 | 0.24 | 0.24 | 0.24 | | | | |
| | compound | amine 1 | | | | | | | | |
| | having a | Polylactone- | | | | | | | | |
| | polyester | amine 2 | | | | | | | | |
| | structure | Polylactone- | | | | | | | | |
| | | amine 3 | | | | | | | | |
| | | Polylactone- | | | | | 0.24 | 0.24 | 0.24 | 0.24 |
| | | amine 4 | | | | | | | | |
| | | Polylactone- | | | | | | | | |
| | | amine 5 | | | | | | | | |
| | | Polylactone- | | | | | | | | |
| | | amine 6 | | | | | | | | |

| | Polycarboxylic acid | | | | | | | | |
|---|---|---|---|---|---|---|---|---|---|
| | amine | | | | | | | | |
| | Polyester polycarboxylic | | | | | | | | |
| | acid | | | | | | | | |
| | Polyether-amine | | | | | | | | |
| Solvents | 1,2-Hexanediol | 30.0 | 30.0 | 30.0 | 30.0 | 30.0 | 30.0 | 30.0 | 30.0 |
| | (C6H14O2) | | | | | | | | |
| | 2-Phenoxy Ethanol | 5.00 | 5.00 | 5.00 | 5.00 | 5.00 | 5.00 | 5.00 | 5.00 |
| | (C8H10O2) | | | | | | | | |
| | Purified water | Balance | Balance | Balance | Balance | Balance | Balance | Balance | Balance |
| Total | | 100 | 100 | 100 | 100 | 100 | 100 | 100 | 100 |
| Evaluations | Dispersibility | A | B | A | B | B | B | B | C |
| | Luster | A | A | A | A | A | B | B | B |
| | Water resistance | A | A | B | B | A | A | C | C |

Here is a supplement to Tables 1 to 7.

### Base-Metal Pigment

The “Particle diameter D50” in the tables represents the volume-average particle diameter D50 and was measured using Microtrac MT-3300 (MicrotracBEL, a laser diffraction/scattering particle size distribution analyzer).

The average thickness of particles of the base-metal pigment in the examples and comparative examples was 15 nm. This was determined by measuring the thickness of any 50 particles of the base-metal pigment by atomic force microscopy using NanoNavi B-Sweep (SII NanoTechnology) and averaging the measurements.

### Surface Treatment Agents

In the following description, a compound represented by formula (1) or (2) is referred to as a specific surface treatment agent.

(R¹—)P(OH)(OH)₂ (1)

(R²—O—)ₐP(O)(OH)₃₋ₐ (2)

(In the formulae, R¹ and R² independently represent a hydrocarbon group having 12 or more carbon atoms, optionally substituted with one or more substituents. a is 1 or 2.)
Octadecyl (C₁₈H₃₇) phosphonic acid: Tokyo Chemical Industry's “O0371” (product code), a specific surface treatment agent represented by formula (1).
Octadecyl (C₁₈H₃₇) phosphoric acid: SC Organic Chemical's “Phoslex A-18,” a specific surface treatment agent represented by formula (2) and 1:1 mixture of a monoester (a is 1) and a diester (a is 2).
Dodecyl (C₁₂H₂₅) phosphonic acid: Tokyo Chemical Industry's “D4809” (product code), a specific surface treatment agent represented by formula (1).
Tridecyl (C₁₃H₂₇) phosphoric acid: SC Organic Chemical's “Phoslex A-13,” a specific surface treatment agent represented by formula (2) and 1:1 mixture of a monoester and a diester.
Dodecyl (C₁₂H₂₅) phosphoric acid: SC Organic Chemical's “Phoslex A-12,” a specific surface treatment agent represented by formula (2) and 1:1 mixture of a monoester and a diester.
Octyl (C₈H₁₇) phosphonic acid: Tokyo Chemical industry's “O0380” (product code), not a specific surface treatment agent.
FHP: 2-(Perfluorohexyl)ethylphosphonic acid (Unimatec), not a specific surface treatment agent.

### Dispersants

Polycarhoxylic acid amine: Product name “DISPARLON 1831,” Kusumoto Chemicals
Polyether-amine: Product name “T5000,” Mitsui Chemicals

### 3.3 Evaluations

### Dispersibility

For each example and each comparative example, a 20 kHz-sonicated diethylene glycol diethyl ether-containing 5% by mass base-metal pigment suspension obtained during the production of the aqueous composition was sampled. The metal particles in this sample were dispersed with ESLEAM AD-374M (NOF), a dispersant that exhibits good dispersibility in nonaqueous media, and the resulting dispersion was analyzed using Microtrac MT-3300 (MicrotracBEL, a laser diffraction/scattering particle size distribution analyzer) for the volume-average diameter D50 of the metal particles contained therein. The volume-average diameter D50 of the metal particles contained in this dispersion was used as the reference value.

A 100-ml aliquot of the finished aqueous composition of the example or comparative example was sealed tightly in a glass container, and this glass container was left at room temperature for a month. Then the container was shaken ten times, and the volume-average diameter D50 of the metal particles in the composition was measured. The measured D50 was compared with the reference value, and the dispersibility of the metal particles was graded according to the criteria below. The smaller the percentage of the volume-average diameter D50 of the metal particles in the aqueous composition to the reference value is, the better the composition is in the dispersibility (redispersibility) of the metal particles. Grades A to C were considered good levels. The reference value was assumed to be 100%. In the examples in which the average diameter of the metal particles was greater than 3 μm, precipitates of the metal particles were observed after the 1-month storage. The dispersibility grades for these examples were determined after the metal particles were dispersed once again by shaking the container as described above.

### Grading Criteria

A: The percentage of the D50 of the metal particles in the aqueous composition to the reference value is less than 110%.
B: The percentage of the D50 of the metal particles in the aqueous composition to the reference value is 110% or more and less than 150%.
C: The percentage of the D50 of the metal particles in the aqueous composition to the reference value is 150% or more and less than 200%.
D: The percentage of the D50 of the metal particles in the aqueous composition to the reference value is 200% or more and less than 500%.
E: The percentage of the D50 of the metal particles in the aqueous composition to the reference value is 500% or more

### Luster

For each example or comparative example, a recording was produced using a modified version of Seiko Epson's SC-S80650. The nozzle density of the nozzle rows of the ink jet head was 360 npi, or 360 nozzles per inch. The ink jet head was filled with the pigment composition of the example or comparative example. The waveform for driving the ink jet head was optimized for the best ejection. The recording medium was a polyvinyl chloride film (Mactac; Mactac 5829R). In the recording job, the attachment density of the ink in the recorded pattern was 5 mg/inch², and the recording resolution was 1440×1440 dpi. In Examples 46 to 53, the composition was attached to reach the same density using a bar coater instead. These examples are suitable for use as paints.

The printed area of the recording for the example or comparative example was analyzed using MINOLTA MULTI GLOSS 268 gloss meter for gloss at a measuring angle of 60°, and luster was graded according to the criteria below. The greater the measured gloss is, the better the recording is in luster. Grades A to C were considered good levels.

### Grading Criteria

A: The gloss is 400 or more.
B: The gloss is 350 or more and less than 400.
C: The gloss is 300 or more and less than 350.
D: The gloss is 250 or more and less than 300.
E: The gloss is less than 250.

### Water Resistance

In each example or comparative example, the pigment composition was sealed in a packet, and this packet was left in a temperature-controlled chamber at 70° C. for 6 days. Gas production per unit mass of the composition was determined, and water resistance was graded according to the criteria below. The smaller the gas production is, the better the composition is in water resistance. Grades A to C were considered good levels.

### Grading Criteria

A: The gas production is less than 0.2 mL/g.
B: The gas production is 0.2 mL/g or more and less than 0.4 mL/g.
C: The gas production is 0.4 mL/g or more and less than 1.0 mL/g.
D: The gas production is 1.0 mL/g or more and less than 5.0 mL/g.
E: The gas production is 5.0 mL/g or more,

### 3.4 Evaluation Results

The results of the evaluations are presented in Tables 1 to 7.

In the examples according to an aspect of the present disclosure, the composition contained a base-metal pigment, at least one dispersant, and water, the base-metal pigment was metal particles having a surface treated with a compound represented by formula (1) or (2), the dispersant included an amine compound having a polyester structure, and the composition was an aqueous one. As can be seen from Tables 1 to 7, these examples all achieved good dispersibility and good luster.

Comparing Examples 1 to 6 and Comparative Examples 1 to 3 reveals that the composition combined dispersibility with luster when made with dispersants including an amine compound having a polyester structure. With such dispersants, furthermore, the composition also had good water resistance.

Comparing Examples 7 to 30 and Comparative Examples 4 to 15 reveals that the composition combined dispersibility with luster when the base-metal pigment was metal particles having a surface treated with a specific surface treatment agent. With such a base-metal pigment, furthermore, the composition tended to have better water resistance.

The results for Examples 1 to 6 indicate that the composition tended to be better in dispersibility, luster, and water resistance with increasing molecular weight of the amine compound having a polyester structure. The composition, furthermore, tended to be better in dispersibility, luster, and water resistance when the acid and amine numbers of the amine compound having a polyester structure were in particular ranges.

The results for Examples 1 to 30 indicate that compositions made with various specific surface treatment agents combined dispersibility with luster. The composition, furthermore, tended to be better in dispersibility, luster, and water resistance with increasing number of carbon atoms in the hydrocarbon group in the specific surface treatment agent.

The results for Examples 1, 7, and 31 to 34 indicate that the composition tended to be better in dispersibility, luster, and water resistance when the specific surface treatment agent content in relation to the metal particles was in a particular range.

The results for Examples 1 and 35 to 37 indicate that the composition combined dispersibility with luster regardless of proportions of solvents.

The results for Examples 1, 4, 7, 10, and 38 to 45 indicate that the composition tended to be better in dispersibility and luster when the dispersant content in relation to the metal particles was in a particular range.

The results for Examples 1, 4, 7, 10, and 46 to 53 indicate that the composition tended to be better in dispersibility when the volume-average particle diameter D50 of the base-metal pigment was smaller than 9 μm.

From the embodiments described above, the following is derived.

A form of a pigment composition contains:
a base-metal pigment, at least one dispersant, and water, wherein:
the base-metal pigment is metal particles having a surface treated with at least one compound. represented by formula (1) or (2):

(R¹—)P(OH)(OH)₂ (1)

(R²—O—)ₐP(O)(OH)₃₋ₐ (2)

where R¹ and R² independently represent a hydrocarbon group having 12 or more carbon atoms, optionally substituted with one or more substituents, and a is 1 or 2;
the dispersant includes an amine compound having a polyester structure; and
the pigment composition is an aqueous one.

In the above form of a pigment composition,
the amine compound having a polyester structure may be an amine compound having a polylactone structure.

In any of the above forms of a pigment composition,
the amine compound. having a polyester structure may have a weight-average molecular weight of 3000 to 100,000.

In any of the above forms of a pigment composition,
the amine compound having a polyester structure may have an acid number of 5 to 80 mg KOH/g and an amine number of 5 to 80 mg KOH/g.

In any of the above forms of a pigment composition,
the amount of the amine compound having a polyester structure may be from 0.1% to 50% by mass, with the amount of the metal particles being 100% by mass.

In any of the above forms of a pigment composition,
the amount of the compound. represented by formula (1) or (2) may be from 1% to 50% by mass, with the amount of the metal particles being 100% by mass.

In any of the above forms of a pigment composition,
the metal particles may be particles of aluminum or an aluminum alloy.

In any of the above forms of a pigment composition,
the volume-average particle diameter D50 of the base-metal pigment may be from 3 to 15 μm.

In any of the above forms of a pigment composition,
the volume-average particle diameter D50 of the base-metal pigment may be 1 μm or less.

In any of the above forms of a pigment composition,
for the compound represented. by formula (1) or (2), the R¹, in formula (1) , or the R², in formula (2), may be a hydrocarbon group having 15 to 30 carbon atoms.

In any of the above forms of a pigment composition,
the metal particles may be in flake shape.

A form of a coloring method includes
attaching a coloring composition to a substrate, wherein a pigment composition in any of the above forms is the coloring composition.

The present disclosure is not limited to the above embodiments, and many variations are possible. For example, the present disclosure embraces configurations substantially identical to those described in the embodiments, such as configurations identical in function, methodology, and results to or having the same goal and offering the same advantages as the described ones. The present disclosure also includes configurations created by changing any nonessential part of those described in the above embodiments. Furthermore, the present disclosure encompasses configurations identical in operation and effect to or capable of fulfilling the same purposes as those described in the above embodiments. Configurations obtained by adding any known technology to those described in the embodiments are also part of the present disclosure.

What is claimed is:

1. A pigment composition comprising:
a base-metal pigment, at least one dispersant, and water, wherein:
the base-metal pigment is metal particles having a surface treated with at least one compound. represented by formula (1) or (2):
(R¹—)P(OH)(OH)₂ (1)
(R²—O—)ₐP(O)(OH)₃₋ₐ (2)
where R¹ and R² independently represent a hydrocarbon group having 12 or more carbon atoms, optionally substituted with one or more substituents, and a is 1 or 2;
the dispersant includes an amine compound having a polyester structure; and
the pigment composition is an aqueous one.

2. The pigment composition according to claim 1, wherein:
the amine compound having a polyester structure is an amine compound having a polylactone structure.

3. The pigment composition according to claim 1, wherein:
the amine compound having a polyester structure has a weight-average molecular weight of 3000 to 100,000.

4. The pigment composition according to claim 1, wherein:
the amine compound having a polyester structure has an acid number of 5 to 80 mg KOH/g and. an amine number of 5 to 80 mg KOH/g.

5. The pigment composition according to claim 1, wherein:
an amount of the amine compound having a polyester. structure is from 0.1% to 50% by mass, with an amount of the metal particles being 100% by mass.

6. The pigment composition according to claim 1, wherein:
an amount of the compound represented by formula (1) or (2) is from 1% to 50% by mass, with an amount of the metal particles being 100% by mass.

7. The pigment composition according to claim 1, wherein:
the metal particles are particles of aluminum or an aluminum alloy.

8. The pigment composition according to claim 1, wherein:
a volume-average particle diameter D50 of the base-metal pigment is from 3 to 15 μm.

9. The pigment composition according to claim 1, wherein:
a volume-average particle diameter D50 of the base-metal pigment is 1 μm or less.

10. The pigment composition according to claim 1, wherein:
for the compound represented by formula (1) or (2), the R¹, in formula (1), or the in formula (2), is a hydrocarbon group having 15 to 30 carbon atoms.

11. The pigment composition according to claim 1, wherein:
the metal particles are in flake shape.

12. A coloring method comprising:
attaching a coloring composition to a substrate, wherein:
the pigment composition according to claim 1 is the coloring composition.
